(19) United States
(12) Patent Application Publication
(10) Pub. No.: US 2024/0427004 A1
(43) Pub. Date: Dec. 26, 2024

(54) METHOD FOR RESOLVING ANGLE AMBIGUITIES IN A RADAR NETWORK

(71) Applicants: Mercedes-Benz Group AG, Stuttgart (DE); Robert Bosch GmbH, Stuttgart (DE)

(72) Inventors: Robert KOHLLEPPEL, Bonn (DE); Philipp Ferdinand RAPP, Tübingen (DE)

(21) Appl. No.: 18/691,921

(22) PCT Filed: Aug. 25, 2022
(86) PCT No.: PCT/EP2022/073701

§ 371 Date: Sep. 12, 2024

(30) Foreign Application Priority Data
Sep. 14, 2021 (DE) 10 2021 210 143.7

(51) Int. Cl. G01S 13/72; G01S 13/42; G01S 13/87; G01S 13/931

(52) U.S. Cl. CPC G01S 13/726; G01S 13/426; G01S 13/878; G01S 13/931

(57) ABSTRACT

A method for resolving angle ambiguities in a spatially incoherent radar network includes a surrounding area is scanned by multiple radar sensors. For each radar sensor, individually and independently of the respective other radar sensors, tracks of detected objects are generated in a state space. Tracks of different radar sensors are assigned to each other with the proviso that the tracks plausibly originate from the same object. The tracks assigned to each other are fused for different variants in order to resolve the angle ambiguities, where a respective plausibility measurement is assigned to each variant and the variant with the highest plausibility is selected in order to resolve the angle ambiguities.

The invention concerns a method for resolving angle ambiguities in a spatially incoherent radar network.

During automated, in particular highly automated or autonomous, operation of a vehicle, radar sensors generate a model of the surrounding space by detecting backscatter from stationary and moving objects. However, angle ambiguities can make it difficult to clearly determine the input direction of a signal, and therefore the positions of detected objects.

US 2019/0187268 A1 discloses a method and device for resolving radar angle ambiguities. In it, the angle position of an object is determined from a spatial response with multiple amplitude peaks. To resolve the radar angle ambiguity, a frequency sub-spectrum or multiple frequency sub-spectrums is or are selected, which highlight amplitude or phase differences in the spatial response and analyze an irregular form of the response over a wide field of vision, in order to determine the angle position of an object. This gives the angle position of the object a clear signature that the radar system can detect and use to resolve radar angle ambiguities. Antenna elements of the radar arranged in an array have a distance between them that is greater than one-half of the average wavelength of a reflected radar signal that is used to detect the object.

The intent of the invention is to provide a new type of method for resolving angle ambiguities in a spatially incoherent radar network.

The invention achieves this goal by means of a method having the features presented in claim 1.

Advantageous embodiments of the invention are the object of the subordinate claims.

In the method for resolving angle ambiguities in a spatially incoherent radar network according to the invention, multiple radar sensors detect a surrounding area, wherein tracks of detected objects are generated in a state space for each radar sensor, individually and independent of the respective other radar sensors. The state space is configured, for example, so that angle ambiguities do not have to be resolved in it. In addition, tracks of different radar sensors are assigned to each other with the proviso that the tracks plausibly originate from the same object. The tracks assigned to each other are fused for different variants in order to resolve the angle ambiguities, wherein a respective plausibility measurement is assigned to each variant. The variant with the highest plausibility is then selected in order to resolve the angle ambiguities.

Using the disclosed method, angle ambiguities of object positions can be resolved by means of plausibility checks done by multiple radar sensors in a radar network. This can reduce the number of falsely positioned objects, also known as ghost objects, due to angle ambiguities, leading to significant improvement of a surroundings model generated by radar sensors. In the context of a system for automated operation of a vehicle, driving operation can thereby be significantly improved. For example, braking maneuvers for objects that are not actually located in a particular position can be avoided.

Unlike the current state of the art, the disclosed method is not based on a frequency subspectrum, so it can also be used with radar sensors that do not control resolution of angle ambiguities themselves.

Examples of the invention are explained in more detail below, with reference to figures.

The figures show:

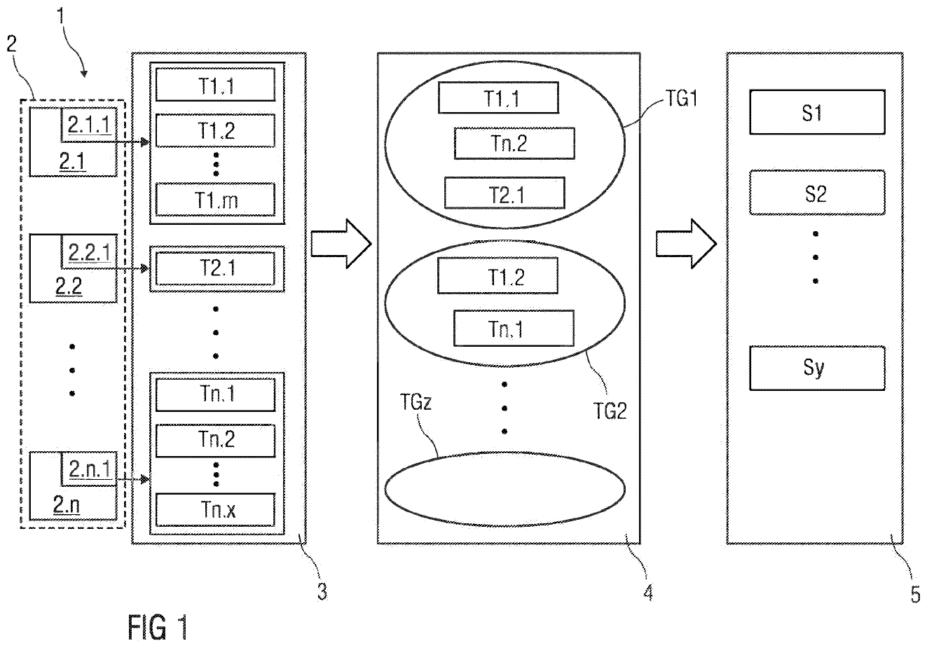

FIG. 1 a schematic block diagram of a device for resolving angle ambiguities in a spatially incoherent radar network,

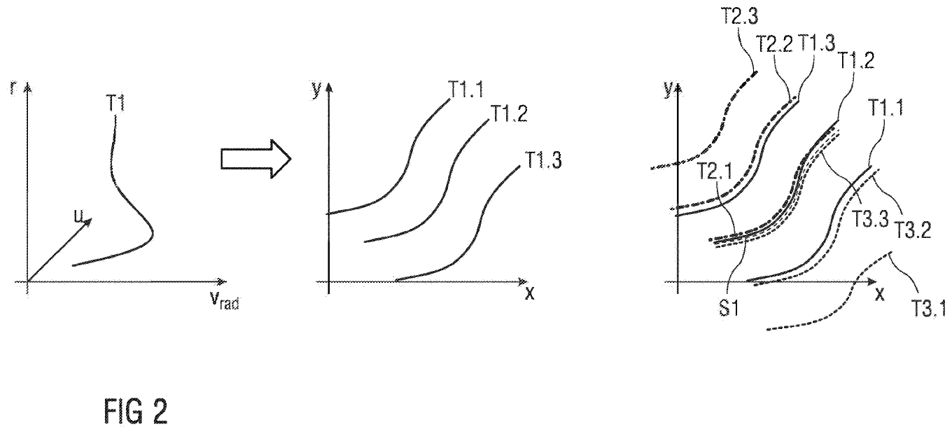

FIG. 2 a schematic conversion of a track detected by a radar sensor into multiple hypothetically derived Cartesian tracks, and a representation of hypothetically derived Cartesian tracks from multiple sensors and a resulting most plausible fused track,

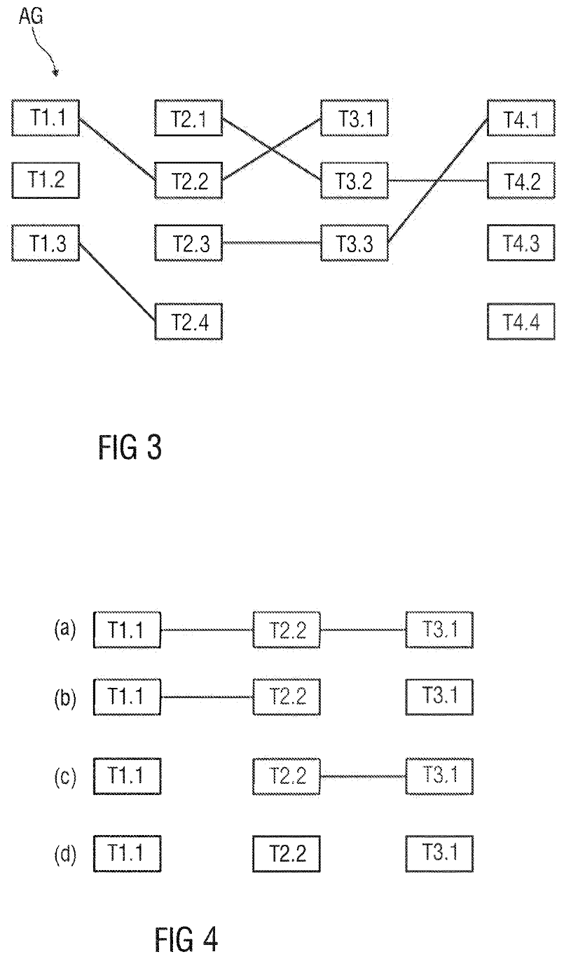

FIG. 3 a schematic preliminary association graph for multiple radar sensors,

FIG. 4 schematic segmentation arrangements taken into consideration when refining the association graph according to FIG. 3,

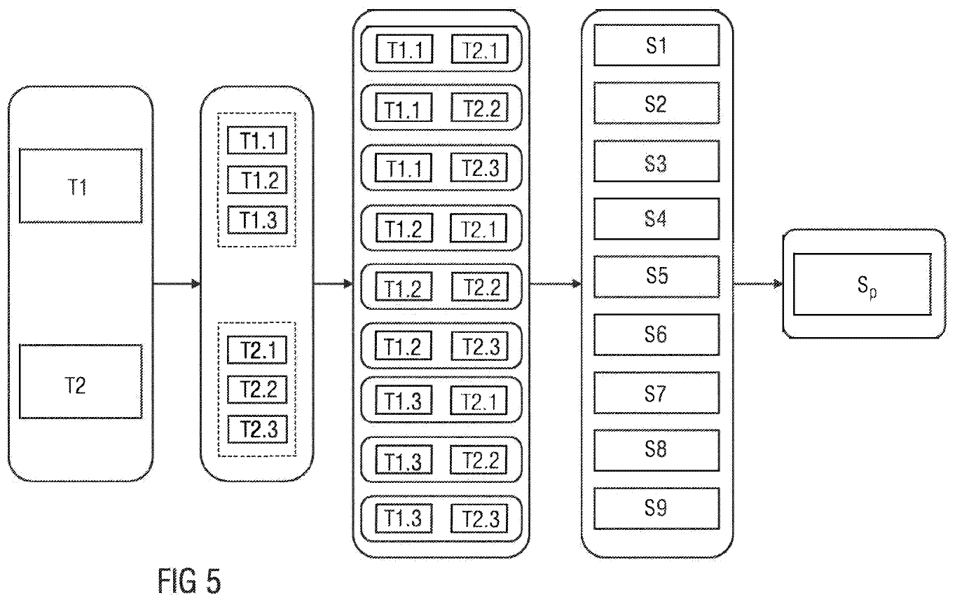

FIG. 5 a schematic representation of data structures for generating a fused track from the average of multiple tracks detected by radar sensors,

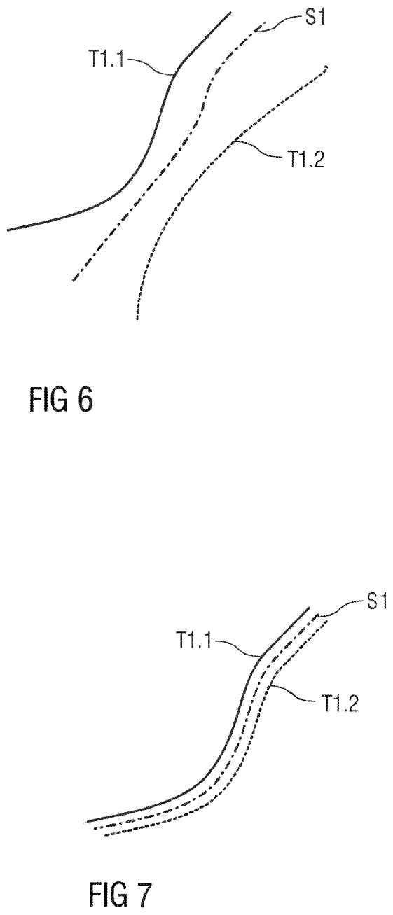

FIG. 6 a schematic representation of a fused track with lower plausibility, and

FIG. 7 a schematic representation of a fused track with higher plausibility.

The same items are identified in all figures with the same designations.

FIG. 1 shows a block diagram of one possible embodiment of a device 1 for resolving angle ambiguities in a spatially incoherent radar network 2 with multiple radar sensors 2.1 to 2.n.

Radar sensors 2.1 to 2.n for vehicle applications can be affected by angle ambiguities. In addition to normal measurement uncertainties, such radar sensors 2.1 to 2.n cannot clearly detect the angle of incidence for an object's signal. In other words, the radar sensor 2.1 to 2.n can only determine that a signal from any angle φ₀, . . . , φ_{N-1} outward is reaching them, where N is a total number of ambiguities. Using a radar sensor 2.1 to 2.n it is possible, based on an illuminated field of vision or on internal target tracking, for example, to determine which angle ambiguity is the most probable. For further processing, the radar sensor 2.1 to 2.n may only output this most probable angle or other angles that are also possible.

In many cases, the most probable angle measurements correspond to the correct object position. In those cases, tracking and fusion algorithms that ignore the ambiguity of the radar measurements provide good results. In cases in which the radar sensor 2.1 to 2.n falsely resolves the angle ambiguity, such algorithms are likely to provide highly erroneous results. In particular, they can output ghost objects, i.e., show objects in positions where actually nothing is located. Because the effects that cause radar sensors 2.1 to 2.n to incorrectly resolve angle ambiguities can exist for long periods of time, these ghost objects can also be long-lived. In automated, in particular highly automated or autonomous, driving operation of a vehicle, such ghost objects can significantly affect driving behaviors, leading to emergency braking for no reason, for example.

To prevent the recognition of such ghost objects, it is possible to increase wavelength values for generating objects based on radar data. However, this results in decreased reliability, and therefore usefulness, of the radar sensors 2.1 to 2.n. Additional problems can also result from this, such as late recognition or even missed objects.

Therefore, even if they appear with only relatively low frequency, angle ambiguities of tracking and fusion algorithms should not be ignored. In particular, angle ambiguities in the so-called spawn phase, i.e., when tracks for the object are initialized, are recognized and taken into consideration, because as soon as a track is generated, additional ambiguous measurement updates to it keep it from being resolved in such a way that it agrees with the previous resolution. In addition, reliable initialization of the track is necessary in order to be able to handle emergency situations, such as the appearance of pedestrians in the roadway who enter the field of vision of the radar sensor 2.1 to 2.n suddenly, in particular if the vehicle with the radar sensor 2.1 to 2.n is already at a short distance from the pedestrian. Emergency situations can also arise due to obstacles located at a short distance from the vehicle, such as a load that has fallen into the roadway, which because of their backscatter characteristics can only be recognized at shorter distances by radar sensors 2.1 to 2.n or other sensors.

In order to resolve these problems, a method for resolving angle ambiguities in a spatially incoherent radar network 2 is implemented using the device 1.

The method is configured to process and determine angle ambiguities in radar measurements with object spawning and relies on the use of multiple radar sensors 2.1 to 2.n, which detect overlapping and/or adjacent detection areas or fields of vision in the surroundings of a vehicle on which the sensors are located (hereinafter designated as an ego vehicle). Implementing the device 1 is based on the goal of avoiding the use of a complete “Multiple-Hypothesis Tracking Algorithm,” which is more difficult to implement and very computationally intensive.

The radar sensors 2.1 to 2.n scan the surroundings, wherein sensor-tracking modules 2.1.1 to 2.n. 1 measure tracks T1.1 to T1.m . . . . Tn.1 to Tn.x for detected objects from data detected by the radar sensors 2.1 to 2.n and send them to an association module 3. The sensor-tracking modules 2.1.1 to 2.n. 1 generate and manage the tracks T1.1 to T1.m . . . . Tn.1 to Tn.x independently for each radar sensor 2.1 to 2.n. The tracks T1.1 to T1.m . . . . Tn.1 to Tn.x use a state space of measurement quantities, in particular a distance, shown in more detail in FIG. 2, from a detected and/or tracked object to the radar sensor 2.1 to 2.n, a radial velocity v_{rad}, and a direction cosine u. The direction cosine u designates the cosine or sine of the angle of incidence for each angle definition. Due to the use of this special state space, the sensor-tracking module 2.1.1 to 2.n.1 does not have to resolve angle ambiguities, because the direction cosine u, which designates an angle of incidence, does not influence the distance r to the radar sensor 2.1 to 2.n and the radial velocity v_{rad} of the state in the prediction step.

In addition, the tracks T1.1 to T1.m . . . . Tn.1 to Tn.x are fused into multi-sensor track groups TG1 to TGz by a coordinating sub-module 4 of a multi-sensor tracking module.

From each of these multi-sensor track groups TG1 to TGz, a fused track S1 to Sy is generated by a fusing module 5.

However, as shown in more detail in FIG. 2, the angle ambiguity must be considered when converting a detected sensor track T1 to a derived hypothetical Cartesian track T1.1 to T1.3.

In this regard, the left portion of FIG. 2 shows a detected sensor track T1 which, for example, according to

$${u}_{n} = {u}_{tr} + n Δ u \qquad ( 1 )$$

is converted into multiple hypothetically derived Cartesian tracks T1.1 to T1.3 shown in the center of FIG. 2. Here, uₜᵣ is the direction cosine u of the track s in sensor coordinates for which the ambiguity was not resolved. nΔu is the distance between possible resolutions of the ambiguity and uₙ is the nth possible resolution.

Each of the three hypotheses corresponds to a possibility for resolving the angle ambiguity.

In the right-hand portion of FIG. 2, hypothetically derived Cartesian tracks T1.1 to T1.3, T2.1 to T2.3, T3.1 to T.3.3 and a resulting most plausible fused track S1 are shown for tracks detected by multiple radar sensors 2.1 to 2.n.

The derived Cartesian tracks T1.1 to T1.3 are located in a Cartesian reference system with the coordinates x, y, for example an integrated driving state coordinate system, also known as an Integrated Driving State Frame, or IDS. The derived Cartesian tracks T1.1 to T1.3 exist therein only from a position standpoint.

Due to the angle ambiguity, there are multiple derived Cartesian tracks T1.1 to T1.3, wherein a number of these tracks T1.1 to T1.3 correspond to a number of ambiguities in the angle measurement. Each derived Cartesian track T1.1 to T1.3 is converted to only one of multiple hypotheses, such as a sensor track T1 to a Cartesian track T1.1 to T1.3.

On variant of the derived Cartesian track T1.1 to T1.3 is a so-called timestamp-adjusted-derived Cartesian track. “Timestamp-adjusted” refers here to the fact that, for this type of track, the timestamp will be specified in such a way that it agrees with the sensor tracking modules 2.1.1 to 2.n.1.

For example, sensor tracks T1, T2 are converted to timestamp-adjusted-derived Cartesian tracks T1.1 to T1.m . . . . Tn.1 to Tn.x with the same timestamps, so that these tracks T1.1 to T1.m . . . . Tn.1 bis Tn.x can be fused. Then tₚ is the update time for a track T1.1 to T1.m . . . . Tn.1 to Tn.x with an index p and tₗ is the time stamp for a common time axis. Then a state of the track T1, T2 for tₗ is determined by
converting the track T1, T2 to a Cartesian track T1.1 to T1.m . . . . Tn.1 to Tn.x with a state ˜x_{p,k} and a co-variance matrix ˜P_{p,k},
including prediction of the state of the time stamp tₗ, in order to get the state x_{p,l} with the co-variance matrix P_{p,l}.

The track T1.1 to T1.m . . . . Tn.1 to Tn.x contains an indicator variable ˜Dₚ, which is equal to 1 if the tracked target object was recognized in the time step tk. Otherwise it is 0. For the timestamp-adjusted-derived Cartesian tracks T1.1 to T1.m . . . . Tn.1 to Tn.x, for time stamp I the corresponding variable Dₚ is set to the value of ˜Dₚ of the timestamp tₖ that precedes it. In this way there is a constant record of whether the tracked target object was recognized at the previous opportunity.

For example, a fused track S1 to Sy is created by calculating a fused state as a weighted average from the states of the timestamp-adjusted-derived Cartesian tracks T1.1 bis T1.m . . . . Tn.1 bis Tn.x. In other words, for timestamp-adjusted-derived tracks T1.1 to T1.m . . . . Tn.1 to Tn.x with a state xₚ and the co-variance matrix Pₚ, the fused track state is

$${x}_{l} = {P}_{l} ( {{\sum }_{p = 0}^{{P}_{st} - 1} [ {P}_{p , l} ]}^{- 1} {x}_{pl} ) \qquad ( 2 )$$

Where Pₛₜ is a number of tracks T1.1 to T1.m . . . . Tn.1 to Tn.x that contribute to the fused track S1 to Sy, and

$${P}_{l} = {( {{\sum }_{p = 0}^{{P}_{st} - 1} [ {P}_{p , l} ]}^{- 1} )}^{- 1} \qquad ( 3 )$$

is the co-variance matrix of the fused track S1 to Sy at the time point l.

FIG. 3 shows an example of a preliminary association graph AG. Nodes on the association graph AG are tracks T1.1 to T1.m . . . . Tn.1 to Tn.x, and (weighted) connections represent preliminary associations. FIG. 4 shows an example of segmentation arrangements (a) to (d), taken into consideration when refining the association graph AG. Segmentation (a) corresponds to an original preliminary association from a preliminary association graph AG. In segmentation arrangements (b), (c), and (d), one or both of the preliminary associations are removed.

A multi-sensor tracking module creates multi-sensor track groups TG1 to TGz, to which it assigns tracks T1.1 to T1.m . . . . Tn.1 to Tn.x detected by radar sensors 2.1 to 2.n that probably show the same target object. A track T1.1 to T1.m . . . . Tn.1 to Tn.x can thereby include tracks T1.1 to T1.m . . . . Tn.1 to Tn.x from only one radar sensor 2.1 to 2.n or also from multiple radar sensors 2.1 to 2.n.

Here the assignment is done in two steps: In a first step, tracks T1.1 to T1.m . . . . Tn.1 to Tn.x are assigned between adjacent radar sensors 2.1 to 2.n with overlapping detection ranges using a cost matrix and a so-called Munkres algorithm. The cost matrix is based on the plausibility that two tracks T1.1 to T1.m . . . . Tn.1 to Tn.x originate from the same target object. This first step yields an association graph AG in which the nodes represent tracks T1.1 to T1.m . . . . Tn.1 to Tn.x, and (weighted) connections of preliminary associations, as shown in FIG. 3.

In a second step, the connections are removed from the association graph AG. In one exemplary case for such a removal, Track “A” plausibly originates from the same target object as Track “B,” Track “B” plausibly originates from the same target object as Track “C,” but it is not plausible that Tracks “A,” “B,” and “C” all represent the same target object. Although this case seems counterintuitive, it can occur due to ambiguous angle measurements.

A multi-sensor track group TG1 to TGz with tracks T1.1 to T1.m . . . . Tn.1 to Tn.x from multiple radar sensors 2.1 bis 2.n delivers hypotheses for fused tracks T1.1 to T1.m . . . . Tn.1 to Tn.x with multiple radar sensors 2.1 to 2.n. Due to the combination of hypotheses related to converting sensor tracks T1, T2 into derived Cartesian tracks T1.1 to T1.m . . . . Tn.1 to Tn.x, there are multiple hypotheses. For example, for a multi-sensor track group TG1 to TGz generated from two sensor tracks T1, T2, where each track T1, T2 contains three hypothetical conversions to derived Cartesian tracks T1.1 to T1.m . . . . Tn.1 to Tn.x, there are a total of 3×3=9 hypothetical fused tracks T1.1 to T1.m . . . . Tn.1 to Tn.x. This is shown in more detail in FIG. 5.

The multi-sensor track group module, using multiple timestamp-adjusted-derived Cartesian tracks T1.1 to T1.m . . . . Tn.1 to Tn.x, in particular one per sensor track T1, T2, creates a fused track S1 bis Sy, where each fused track S1 to Sy has a scaled plausibility value. From that, a most plausible fused track k Sₚ is selected.

For example, an initial step assigns tracks T1.1 to T1.m . . . . Tn.1 to Tn.x to multi-sensor track groups TG1 to TGz as preliminarily assigned tracks. In many cases, these preliminary associations are maintained; however, in other cases it is not logical to use them. The goal of creating multi-sensor track groups TG1 to TGz from the preliminary associations involves a heuristic segmentation algorithm: This algorithm first finds all possible segmentation arrangements of the preliminarily assigned tracks. This allows preliminarily associated tracks A, B, and C to be distributed into
multi-sensor track groups {A, B} and {C},
multi-sensor track groups {A}, {B,C},
multi-sensor track groups {A}, {B}, {C} or
the combined multi-sensor track group {A, B, C}.

Then the segmentation algorithm calculates the plausibility of each segmentation arrangement, in order to select the segmentation arrangement with the highest plausibility. For a given segmentation arrangement and each segment with the index m for that segmentation arrangement, the segmentation algorithm constructs a fused track S1 to Sy, determines its plausibility W_{mt,}, a length L_{mt,m} and an average plausibility ˜W_{mt,m}=W_{mt,m}/L_{mt,m}. The plausibility of the segmentation arrangement is then stated by

$${W}_{segmentation} = {\prod }_{m = 0}^{M - 1} {\tilde{W}}_{mt , m} \frac{1}{M} {\sum }_{m = 0}^{M - 1} {L}_{mt , m} \qquad ( 4 )$$

Where M is the total number of segments within the segmentation arrangement. Then the segmentation arrangement with the highest plausibility is selected.

FIG. 6 is a schematic representation of a fused track S1 with lower plausibility. The original two derived Cartesian tracks T1.1, T1.2 have very low agreement. The fused track S1 does not agree with the derived Cartesian track T1.1, T1.2, so the algorithm calculates a low plausibility value.

FIG. 7 shows a representation of a fused track S1 with higher plausibility. Here the original two derived Cartesian tracks T1.1, T1.2 have high agreement, so that the fused track S1 also agrees with the derived Cartesian track T1.1, T1.2, and the algorithm calculates a high plausibility value.

Plausibility is dependent upon how well each timestamp-adjusted-derived Cartesian track T1.1 to T1.m . . . . Tn.1 to Tn.x agrees with the resulting fused track S1 to Sy. In addition, the likelihood that a target object tracked by the involved radar sensors 2.1 to 2.n should have been detected, based on the fused track S1 to Sy and a sensor model, is determined. If the actual recognition or non-recognition results agree well with a recognition likelihood, this leads to higher plausibility of the fused track S1 to Sy. Next, the fused track Sₚ with the highest plausibility value is selected from among the multiple hypothetical tracks S1 to Sy. By calculating the various hypotheses for the fused tracks S1 to Sy and their plausibility ranking, the goal of resolving angle ambiguities is achieved.

For example, the plausibility of a fused track is determined using a heuristic process:
If the timestamp-adjusted-derived Cartesian tracks T1.1 to T1.m . . . . Tn.1 to Tn.x do not chronologically overlap, then the fused track S1 to Sy has length 0. In this case, the plausibility is set at Wₘₜ=0.
Otherwise, a weighting variable is calculated for each derived Cartesian track p and each timestamp l. For timestamps with Dₚ=0 (no recognition) a weight wₚ=1−P_{D}(xₗ; νₚ) is assigned, where up is an ID of the radar sensor 2.1 to 2.n from which the track p was received and where P_{D}(x; ν) is the likelihood of a target object with a state x being recognized by a radar sensor 2.1 to 2.n with the ID ν. For timestamps with D_{p,l}=1 (target recognized) the weight is determined according to

$${w}_{p , l} = \frac{{P}_{D} ( {x}_{l} , {v}_{p} ) p ( {x}_{p , l} ; {x}_{l} , {P}_{l} + {P}_{p , l} )}{{P}_{D} ( {x}_{l} , {v}_{p} ) p ( {x}_{p , l} ; {x}_{l} , {P}_{l} + {P}_{p , l} ) + κ} \qquad ( 5 )$$

where p (x; y, P) is the Gaussian probability density function with the average value y and the co-variance matrix P. In addition, K is a configurable parameter.
If the target object is not tracked by a radar sensor 2.1 to 2.n, i.e., there are no tracks T1.1 to T1.m . . . . Tn.1 to Tn.x from that radar sensor 2.1 to 2.n in the multi-sensor track group TG1 to TGz, all time indices are treated as time indices for missed recognitions and the weights are set to w_{p,l}=1−P_{D}(xₗ; νp). Therefore, p is an index for the missed track T1.1 to T1.m . . . . Tn.1 to Tn.x and νₚ is an index for the radar sensor 2.1 to 2.n that missed the track T1.1 to T1.m . . . . Tn.1 to Tn.x. With these definitions, the missed track T1.1 to T1.m . . . . Tn.1 to Tn.x can be handled consistently when calculating the fused track plausibility.
Then, the plausibility of the fused track S1 to Sy is

$${W}_{mt} = {\sum }_{p = 0}^{{L}_{mt} - 1} {\prod }_{p = 0}^{{P}_{sensors} - 1} {w}_{p , l} \qquad ( 6 )$$

where Lₘₜ is a number of time steps for the fused track S1 to Sy and P_{Sensors} is the number of radar sensors 2.1 to 2.n. This value corresponds to the combined number of tracks T1.1 to T1.m . . . . Tn.1 to Tn.x and missing tracks T1.1 to T1.m . . . . Tn.1 to Tn.x.

The aforementioned algorithm is primarily intended for continuous tracking. However, it is able to track data exclusively in a short time interval, in order to receive fused tracks S1 to Sy that are used for track initialization or as spawning candidates for a main tracking algorithm. This usage limitation allows for simplification of the plausibility calculation and track fusing. In other words, a situation in which sensor tracks T1, T2 represent the same target object for a determined time interval and—due to a track identity change—not for another time interval is not processed.

### LIST OF REFERENCE INDICATORS

1 Device

2 Radar network

2.1 to 2.n Radar sensor

2.1.1 to 2.n.1 Sensor tracking module

3 Association module

4 Assignment sub-module

5 Fusing module

(a) to (d) Segmentation arrangements

AG Association graph

r Removal

S1 to Sy Track

Sₚ Track

T1 Sensor track

T2 Sensor track

TG1 to TGZ Multi-sensor track group

T1.1 to T1.m . . . . Tn.1 to Tn.x Track

u Direction cosine

v_{rad} Radial velocity

x Coordinate

y Coordinate

1. (canceled)

2. A method for resolving angle ambiguities in a spatially incoherent radar network, comprising:
a surrounding area is scanned by multiple radar sensors,
for each radar sensor, individually and independently of the respective other radar sensors, tracks of detected objects are generated in a state space,
tracks of different radar sensors are assigned to each other with the proviso that the tracks plausibly originate from the same object,
the tracks assigned to each other are fused for different variants in order to resolve the angle ambiguities,
a respective plausibility measurement is assigned to each variant, and
the variant with the highest plausibility is selected in order to resolve the angle ambiguities.
